(19) United States
(12) Patent Application Publication
(10) Pub. No.: US 2004/0031439 A1
(43) Pub. Date: Feb. 19, 2004

(54) Transfer/fixing member for electrophotographic apparatus

(76) Inventors: Yuko Shimizu, Mie (JP); Takuya Shindo, Mie (JP); Shingo Katayama, Chiba (JP); Yuji Kubo, Chiba (JP); Noriko Yamada, Chiba (JP)

Correspondence Address: Donald S Dowden, Cooper & Dunham, 1185 Avenue of the Americas, New York, NY, 10036, US

(21) Appl. No.: 10/380,925

(22) PCT Filed: Sep. 12, 2001
(86) PCT No.: PCT/JP01/07943

(30) Foreign Application Priority Data
Sep. 18, 2000 (JP) 2000-282546

(51) Int. Cl. B05C 11/00

(52) U.S. Cl. 118/60

(57) ABSTRACT

Transferring and/or fusing part(s) for electrophotographic use consisting of a base and a releasing layer which is made of an organic-inorganic hybrid material containing fluoroalkyl group and formed on said base, is provided in the present invention. Said transferring and/or fusing part(s) have an excellent heat resistance, durability and toner releasing property.

### FIELD OF THE INVENTION

The present invention relates to transferring and/or fusing part(s) such as the intermediate transferring belt used for transferring a toner image formed on the photosensitive substrate to an image supporting base, such as paper, the fusing roller or fusing belt used to fuse said toner image being transferred to said image supporting base, or the transferring and fusing belt used for both transferring and fusing, and the like, within the electrophotographic copying machine, printer, and the like.

### BACKGROUND OF THE INVENTION

In electrophotography, generally, an electrostatic latent image corresponding to the image from the image reading device, is formed on the photosensitive substrate, after which said electrostatic latent image is changed to a toner image by a developing device, and then said toner image is electrostatically transferred to the intermediate transferring belt (primary transfer), and finally a toner image is formed on the image supporter such as paper by transferring again from said intermediate transferring belt to said image supporter (secondary transfer). Said image supporter onto which the final image is transferred is then nipped by a fusing roller or fusing belt to fuse said toner image to said image supporter as a permanent image.

It is requested that said intermediate transferring belt or said transferring and/or fusing belt used in the electrophotography should have an electroconductive property to eliminate electrostatic charge easily without using a static eliminator and further a small elongation (a highly elastic modulus under tension) to give a correct and clear image. Hitherto, polyimide resin in which a conductive filler such as carbon black, conductive metal oxide, or the like, is dispersed, has chiefly been used as a material for said intermediate transferring belt (Japanese Unexamined 63-311263 . . . etc.).

Nevertheless, said intermediate transferring belt and transferring and/or fusing belt made of said polyimide resin have a highly elastic modulus under tension, but have a problem of a poor releasing property for the toner since said belts have tackiness. In a case where an intermediate transferring belt and a transferring and fusing belt having a poor releasing property for the toner are used, the toner may remain on the surface of the belt after the image on the belt has been transferred to the image supporter and said remaining toner may be transferred to the image supporter during the next transferring (off-set) resulting in problems that the toner is accumulated on the surface of the belt causing filming and resulting in transfer obstruction, poor image quality, and so on.

Accordingly, objects of the present invention are to provide an intermediate transferring belt or an intermediate transfer drum used in electrophotography having an improved releasing property for the toner, maintaining a proper electroconductivity, and to provide a fusing roller, a fusing belt or a transferring and fusing belt which is used for both transferring and fusing, having a good heat resistance and durability so that off-set or injuring of the surface of said roller is hard to take place.

### DISCLOSURE OF THE INVENTION

To solve said problems, the present invention is to provide transferring and/or fusing part(s) used in electrophotography wherein an organic-inorganic hybrid releasing layer containing a fluoroalkyl group is formed by the sol-gel process on the base surface of said part(s).

It is preferable that said base is made wholly of polyimide resin and further it is preferable that said organic-inorganic hybrid releasing layer containing said fluoroalkyl group is produced by the reaction between a metal or semimetal alkoxide and an organosilicon compound.

Said transferring and/or fusing part(s) is an intermediate transferring belt or an intermediate transferring drum or a transferring and/or fusing belt, and said base is a resin base having electric conductivity in the case of said intermediate transferring belt or said transferring and/or fusing belt, and said base is a cylindrical metal core in the case of said intermediate transferring drum.

In the case of said intermediate transferring belt or said intermediate transferring drum or said transferring and/or fusing belt, the thickness of said organic-inorganic hybrid releasing layer containing said fluoroalkyl group is preferably in the range of between 0.05 and 100 μm and in the case of said intermediate transfer belt or said transfer and/or fusing belt, the ultraviolet irradiation treatment is preferably used on the surface of said resin base before said releasing layer is formed, and further in the case of said intermediate transferring and/or fusing belt or said transferring and/or fusing belt, an adhesive layer made of a metal oxide formed by the sol-gel process preferably intermediates between said resin base and said releasing layer.

Further the surface resistance of said intermediate transferring belt or said intermediate transferring drum or said transferring and/or fusing belt is preferably in the range of between 5 and 14 log Ω/□ and the volume resistance thereof is preferably in the range of between 5 and 13 log Ω·cm.

Further said transferring and/or fusing part(s) is a fusing roller or a fusing belt.

The thickness of said organic-inorganic hybrid releasing layer containing a fluoroalkyl group is preferably in the range of between 0.2 and 40 mm in the case of said fusing roller, and 0.05 and 100 μm in the case of said fusing belt, and further in the case of said fusing roller, said base is preferably cylindrical metal core, or cylindrical metal covered with a resin, and in the case of said fusing belt, said base is preferably a resin base, and further the ultraviolet irradiation treatment is preferably used on the surface of said resin base before said releasing layer is formed or an adhesive layer made of a metal oxide formed by the sol-gel process preferably intermediates between said resin base and said releasing layer.

By using a compound having fluoroalkyl group as an organic component of said organic-inorganic hybrid material, the tackiness of said releasing layer made of said organic-inorganic hybrid material is reduced and the releasing property of said releasing layer is improved.

Said transferring and/or fusing part(s) of the present invention has a reduced tackiness, resulting in said part(s) having an excellent toner releasing property, and further, an excellent heat resistance and durability, and furthermore, poor image quality as the result of transfer off-set and the like, or surface injury to said fusing part(s) is certainly prevented.

### BRIEF DESCRIPTION OF THE DRAWING

FIG. 1 is a schematic view to illustrate the transferring system using an intermediate transferring belt.

FIG. 2 is a schematic view to illustrate the transferring system using an intermediate transferring drum.

FIG. 3 is a schematic view to illustrate the fusing system using a fusing roller.

FIG. 4 is a schematic view to illustrate the fusing system using a fusing belt.

FIG. 5 is a schematic view to illustrate the transferring and fusing system using a transferring and fusing belt.

Description

1. intermediate transferring belt

11. intermediate transferring drum

21. fusing roller

31. fusing belt

41. transferring and fusing belt

### DETAILED DESCRIPTION

[A Base]

Polyimide resin (PI) having a highly elastic modulus under tension is mainly used as the raw material resin of said resin base used in said transferring and/or fusing part(s) in electrophotography of the present invention, but besides polyimide resin, polyester resin such as polycarbonate resin (PC), polyethylene terephthalate (PET), polybutylene terephthalate (PBT), polyethylene naphthalate (PEN), polyallylate (PAR) and the like, theremoplastic resin such as polyurethane resin (PU) and polyamide resin (PA) can be used as the raw material resin and said raw material resin may be used singly or as a mixture or a polymer alloy of two or more kinds of said raw material resins.

In the case of transferring and fusing belt, a resin having a high heat resistance such as PEN, PAR or PEN-PAR polymer alloy is preferably used as a material.

In the case of an intermediate transferring belt or a transferring and fusing belt, generally a conductive filler is combined in said synthetic resin base to give it conductivity. Said conductive filler may be carbon black such as acetylene black, ketjen black, furnace black, channel black and the like; graftcarbon grafting the hydrophobic oligomer (such as oligomer of styrene, acrylic acid, methacrylic acid, methyl methacrylate and the like) with the functional group of the carbon surface; conductive metal oxide such as titanium oxide, zinc oxide, tin oxide, antimony oxide and the like; conductive metal salt such as conductive barium sulfate, aluminum borate and the like; conductive polymer such as polypyrrole, polyaniline, polyacetylene, poly-p-phenylene, polythiophene, polyfuran, polyphenyl vinylene and the like.

The combining amount of said conductive filler is in such an amount that the resulting intermediate transferring belt or the transferring and fusing belt has a proper resistance and said amount of said conductive filler may be adjusted considering the electric property of said conductive filler, so that concretely the surface resistance of said synthetic resin base may be in the range of between 5 and 14 log Ω/□ and the volume resistance may be in the range of between 5 and 13 log Ω·cm.

A conductive synthetic resin may be used as said resin base itself. In this case the conductive filler may be unnecessary. Said conductive synthetic resin may be an aromatic polyimide including an acid anhydride part and a diamine part in its repetition unit and said aromatic polyimide and said diamine part are bound together through the conjugated system or sulfur atom.

A common additive for the thermoplastic resin such as a rubber, thermoplastic elastomer, lubricant, plasticizer, thermal stabilizer, light stabilizer, flame-retardant, antiflame agent, antioxidant, release agent and the like may be added to said resin base in an amount commonly used.

The elastic modulus under tension of said synthetic resin base is preferably higher than 200 kg/mm², more preferably higher than 250 kg/mm², and the thickness of said resin base is preferably in the range of between 80 and 100 μm in the case of the belt.

[B Releasing Layer]

The releasing layer in the transferring and/or fusing part(s) in the electrophotographic copy of the present invention is made of organic-inorganic hybrid material containing fluoroalkyl group formed on the surface of said base by the sol-gel process and said coating layer has a good heat resistance and durability and further the excellent toner releasing property. In said sol-gel process, the sol solution is used on the surface of said base and then the coated sol solution is heated to desiccate for gelation to form the releasing layer.

The organic-inorganic hybrid material of said leasing layer is preferably produced by the reaction between alkoxide of metal or semimetal and organosilicon compound (Japanese Unexamined Patent Publication No.07-213995, Japanese Unexamined Patent Publication No.10-245490, Japanese Unexamined Patent Publication No.10-95852 . . . etc.).

The metal or semimetal of said alkoxide is such as aluminium, silicon, titanium, vanadium, manganese, iron, cobalt, zinc, germanium, yttrium, zirconium, niobium, cadmium, tantalum and the like which can produce the metal or semimetal alkoxide.

Further any kind of alkoxide may be used in the present invention such as methoxide, ethoxide, propoxide, butoxide. Still further alkoxide derivative in which parts of alkoxyl group are substituted by β-diketone, β-ketoester, alkanolamine, alkylalkanolamine, and the like may be used instead of said alkoxide.

Such as dialkyldialkoxysilane and silanol-terminated polydimethylsiloxane and the like can be used as said organosilicon compound. Such as dimethyldimethoxysilane, dimethyldiethoxysilane, dimethyldipropoxysilane, dimethyldibutoxysilane, diethyldimethoxysilane, diethyldiethoxysilane, diethyldipropoxysilane, diethyldibutoxysilane, dipropyldimethoxysilane, dipropyldiethoxysilane, dipropyldipropoxysilane, dipropyldibutoxysilane, diphenyldimethoxysilane, diphenyldiethoxysilane, diphenyldipropoxysilane, diphenyldibutoxysilane may be used as said dialkyldialkoxysilane. The molecular weight of said silanol-terminated polydimethylsiloxane is preferably in the range of between 400 and 10000.

An organic-inorganic hybrid releasing layer containing fluorine is used in the present invention. To prepare said releasing layer containing fluorine, an organosilicon compound wherein hydrogen(s) of the organic group of said organs silicon compound is(are) substituted partially or wholly by fluorine(s), that is an organosilicon compound containing fluoroalkyl group, is used. Said organosilicon compound is such as an alkoxysilan such as trialkylalkoxysilan, dialkyldialkoxysilane, alkyltrialkoxysilan and the like wherein hydrogen(s) of alkyl group is(are) partially or wholly substituted by fluorine(s).

Said organosilicon compound containing fluoroalkyl group preferably has alkyl group and alkoxy group having a carbon number 1 to 13, and said organosilicon compound is such as 3.3.3-trifluoropropyltriethoxysilan.

Fluoroalkyl alkoxy silanes used in this invention include monofluoro alkyl trialkoxy silane, monofluoro alkyl monoalkyl dialkoxy silane, difluoroalkyl dialkoxy silane, monofluoroalkyl dialkyl monoalkoxy silane, difluoroalky monoalkyl monoalkoxy silane, difluoroalkyl monoalkyl monoalkoxy silane, trifluoroalkyl monoalkoxy silane and the like. Fluoroalkyl groups include —CF₃, —C₂F₅, —C₃F₇, —C₄F₉,—CH₂CH₂CF₃, —CH₂CH₂C₆F₁₃, —CH₂CH₂C₈F₁₇ and the like. Alkyl groups include methyl group, ethyl group, propyl group, butyl group, phenyl group, vinyl group and the like. Alkoxy groups include methxy group, ethoxy group, propoxy group, butoxy group and the like.

To form said releasing layer, first an alkoxide of metal or semimetal is hydrolyzed and then an organic component such as said organosilicon compound is added to said hydrolysate to react to prepare a sol solution. Said organic component may be also added to said alkoxide before hydrolysis.

If desirable, a solvent may be used in preparation of said sol solution. Any kind of solvents which can uniformly disperse or dissolve both said alkoxide and said organosilicon compound may be used. Said solvent may be generally alcohol such as methanol, ethanol and the like and further acetone, toluene, xylene and the like.

Further, to promote said hydrolysis reaction of said alkoxide, hydrochloric acid, phosphoric acid, acetic acid may be preferably used as a catalyst.

In the present invention, it is preferable that more than 50% by weight of fluorine substituted organosilicon compound is contained in said organic component. In a case where said fluorine substituted organosilicon is contained in an amount less than 5.0% by weight in said organic component, the tackiness of the resulting releasing layer may not be improved enough.

Further, the molar ratio of said organic component to said alkoxide as inorganic component (organic component/(organic component+inorganic component)) is preferably in the range of between 0.1 and 0.7. In a case where said molar ratio is below 0.1, the resulting releasing layer becomes brittle and it is feared that said releasing layer can not elastically deform while in a case where said molar ratio is beyond 0.7, the reactant of said organic component and said inorganic component may not gelate.

Above described sol solution is preferably agitated to hydrolyze alkoxide sufficiently and partially dehydrate and condensate said alkoxide to improve the adhering property to said base, especially said resin base.

The resulting sol solution (sol) can be used to coat the surface of said base by a well-known method such as the dip-coating, the spray coating, the roll coating, the flow coating and the like.

The coating film of said sol solution on the surface of said base is dried and desiccated to be finally a releasing layer. Said drying and desiccating may be carried out at a room temperature but heat is generally applied. The heating may be preferably carried out at a temperature between 60 to 450 C. for 20 seconds to 7 hours. Said coating process may be carried out repeatedly if desirable so that said coating layer may have single layer structure or polylayer structure.

Said releasing layer formed by said sol-gel method has generally a thickness in the range between 0.2 and 40 mm in a case where said releasing layer is formed on the surface of the cylindrical metal core of a fusing roller as a elastic layer and in a case where said releasing layer is formed on the resin base of a fusing belt, an intermediate transferring belt, or a transferring and fusing belt as a thin film, a thickness of said coating layer is preferably in the range of between 0.05 to 100 μm.

Said releasing layer made of organic-inorganic hybrid material formed by the sol-gel process has the proper tackiness to release the toner and excellent heat resistance, durability and toner releasing property so that by using the transferring and/or fusing parts having said releasing layer, the problems of the transferring defection caused by the toner remaining and adhesion, the low image quality and the like caused by the remaining and adhesion of the toner are effectively solved to ensure a long life of said transferring and/or fusing parts and the correct and clear image.

Further since said releasing layer formed by the sol-gel process is thin and uniform, in a case where said releasing layer is used in an intermediate transferring belt or a transferring and fusing belt, said releasing layer scarcely effects conductivity of said resin base so that said intermediate transferring belt or transferring and fusing belt can electrostatically adsorb the toner effectively and static electricity charged in said intermediate transferring belt or transferring and fusing belt is also effectively eliminated. To give the desirable conductivity to said intermediate transferring belt or transferring and fusing belt wholly, said conductive filler may be combined to said releasing layer.

Further since said releasing layer is made of organic-inorganic hybrid material, said releasing layer has a proper flexibility and elasticity based on the organic component so that said releasing layer closely attaches to said resin base and in a case where said releasing layer is used in a fusing roller or a transferring and fusing belt, an excellent nipping property is ensured and in a case where said releasing layer is used in a fusing belt or a transferring and fusing belt, said releasing layer does not obstruct the flexibility and the elasticity of the belt. In particular, in a case where said releasing layer is made of an organic-inorganic hybrid material using silanol-terminated polydimethylsiloxane as an organic component, said releasing layer may have an excellent rubber-like elasticity based on flexible siloxane bond as the main chain of polydimethylsiloxane and an excellent flexibility and mechanical strength based on the entanglement of said main chain.

Still further said releasing layer made of organic-inorganic hybrid material gives said transferring and/or fusing parts an excellent wear resistance resulting in a long life.

In the case of said intermediate transferring belt or said transferring and fusing belt, the final surface resistance is preferably 5 to 14 log Ω/□ and the final volume resistance is preferably 5 to 13 log Ω·cm. In a case where the surface resistance and the volume resistance of said intermediate transferring belt or said transferring and fusing belt are below 5 log Ω/□ and 5 log Ω·cm respectively, the electrostatic charge in said intermediate transferring belt or transferring and fusing belt is easily discharged by a low resistance of said belt so that said belt cannot firmly hold the toner image resulting in the blur of the image and the big transfer noise when the image is transferred to the image supporter. On the other hand, in a case where the surface resistance of the belt is beyond 14 log Ω/□ or the volume resistance of the belt is beyond 13 log Ω·cm, the static eliminater is necessary since the surface of the belt is charged by the transfer electric field in the electrostatic transfer.

[C Improvement of Adhesion]

In a case where said base is a resin base, to improve the adhesion between said resin base and said releasing layer, the ultraviolet irradiation treatment may be used on the surface of said resin base before the coating. By said ultraviolet irradiation treatment on the surface of said resin base, the oleophilic group of said resin base may change to the hydrophilic group which can combine with OH group existing in said sol solution, so that the adhesion between said resin base and said releasing layer is improved.

The ultraviolet rays of wave length 185 nm and 254 nm are preferably irradiated onto the surface of said synthetic resin base for from 5 seconds to 60 minutes.

Further, to improve the adhesion between said resin base and said releasing layer, NaOH chemical etching treatment may be used on the surface of said resin base.

Still further, to improve the adhesion between said resin base and said releasing layer, an adhesive layer made of a metal oxide formed by the sol-gel process may intermediate between said resin base and said releasing layer.

Said metal oxide may be an oxide of a metal or a semimetal which can produce alkoxide, such as aluminum, silicon, titanium, vanadium, manganese, iron, cobalt, zinc, germanium, yttrium, zirconium, niobium, cadmium, tantalum and the like. The adhesive layer made of said metal oxide is usually formed on said resin base by sol-gel process as a thin film.

The electric property of said resin base is scarcely changed by said adhesive layer formed on said resin base by the sol-gel process and the thickness of said adhesive layer is preferably in the range of between 0.05 and 5.0 μm.

Further the conductive filler may be mixed in said adhesive layer to give a proper resistance to an intermediate transferring belt or a transferring and fusing belt wholly if desirable.

[D Transferring and/or Fusing Part(s)]

The transferring and/or fusing part(s) of the present invention include an intermediate transferring belt (1), intermediate transferring drum (11), fusing roller (21), fusing belt (31), transferring and fusing belt (41) and the like.

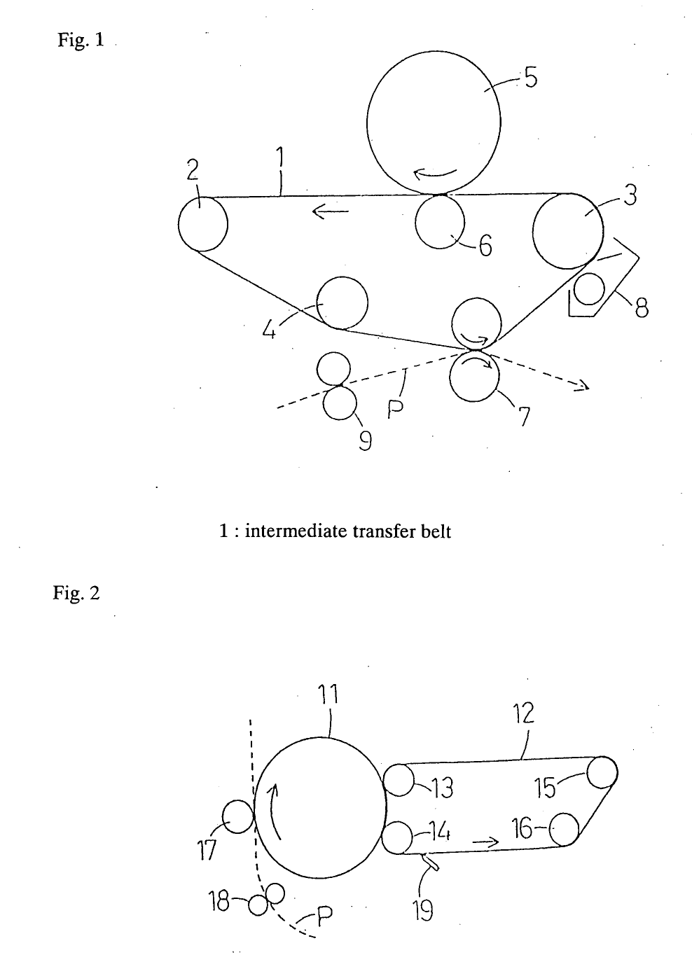

FIG. 1 shows a transferring system using an intermediate transferring belt (1). Said intermediate transferring belt (1) is hanged on a drive roll (2), driven roll (3) and tension roll (4), and is in contact with a photosensitive drum (5) between said drive roll (2) and said driven roll (3). A primary transfer roll (6) is arranged opposite to said photosensitive drum (5) and a pair of secondary transferring rolls (7) opposite to each other are arranged between said tension roll (4) and said driven roll (3) and said belt (1) is nipped between said secondary transferring rolls (7). Still further a belt cleaner (8) is arranged opposite to said driven roll (3).

In the above described transfer system, a toner image formed on said photosensitive drum (5) is primarily transferred to said intermediate transferring belt (1) driven at the same speed as said photosensitive drum (5), and said toner image transferred on said belt (1) is then secondarily transferred on an image supporter such as the paper P which is fed between said secondary transferring rolls (7) by a pair of feed rolls (9). After the secondary transfer, the toner remaining on said belt (1) is removed by said belt cleaner (8).

FIG. 2 shows a transfer system using said intermediate transferring drum (11). A photosensitive belt (12) is hanged on rolls (13,14,15,16) and a transfer roll (17) is in contact with said intermediate transferring drum (11).

In the above described transfer system, the toner image on said photosensitive belt (12) is primarily transferred to said intermediate transferring drum (11) driven at the same speed as said photosensitive belt (12) and toner image transferred on said drum (11) is secondarily transferred to the image supporter such as the paper P which is fed between said drum (11) and said transfer roll (17) by a pair of feed rolls (18). After said primary transfer, the toner remaining on said belt (12) is removed by a belt cleaner (19).

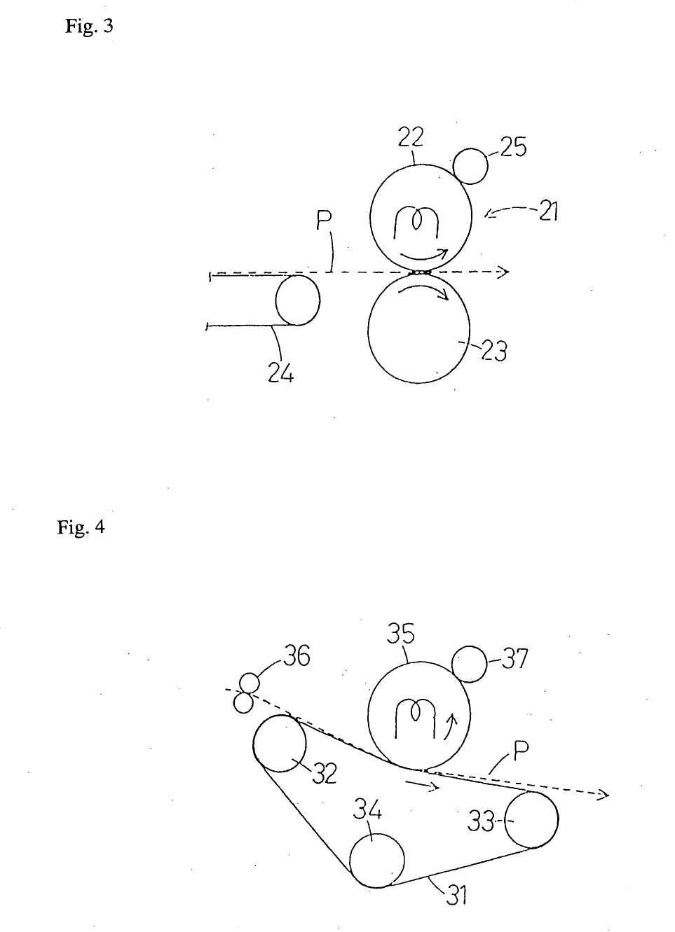

FIG. 3 shows a fusing system using a fusing roller (21). Said fusing roller unit consists of a heat roller (22) and a press roller (23) pressed to said heat roller (22). An image supporter such as the paper P on which the toner image is transferred is fed between said rollers (22,23) rotating together at the same speed from a feed conveyer (24) and the toner constituting the toner image is fused to fix said toner image on said image supporter. The toner adhering to said heat roller (22) is removed by a cleaning roll (25).

FIG. 4 shows a fusing system using a fusing belt (31). Said belt (31) is hanged on a drive roll (32), driven roll (33) and tension roll (34), and heat roller (35) is pressed to said belt (31). Said belt (31) and said heat roller (35) rotate together at the same speed and an image supporter such as the paper P is fed between said belt (31) and said roller (35) by a pair of feed rolls (36) to fuse and fix the toner image to said image supporter. After fusing, the toner adhering to said heat roller (35) is removed by a cleaning roll (37).

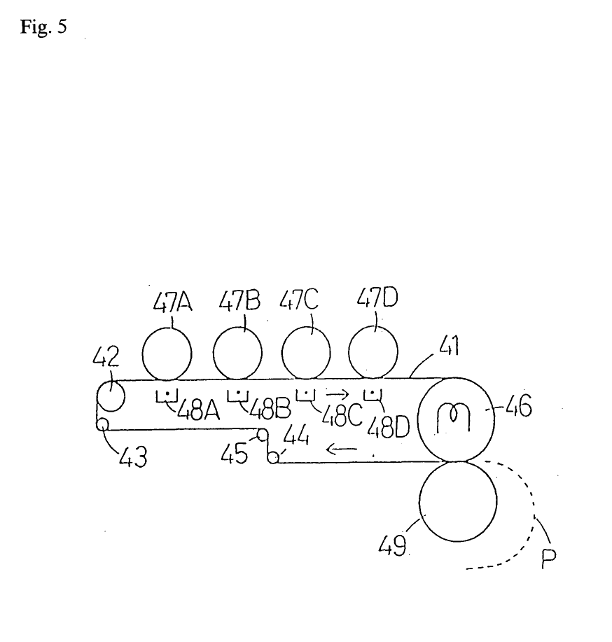

FIG. 5 shows a transferring and fusing system using a transferring and fusing belt (41). Said transferring and fusing belt (41) is hanged on a drive roll (42), guide rolls (43,44), a tension roll (45) and a heat roller (46) and four photosensitive drums (47A, 47B, 47C, 47D) on which toner images are formed respectively, in different colours are adjacent to said transferring and fusing belt (41) between said drive roll (42) and said heat roller (46), and four transferring devices (48A,48B,48C,48D) are arranged opposite respectively to said photosensitive drums (47A,47B,47C,47D) and a press roller (49) is pressed to said heat roller (46).

In said transferring and fusing system, a coloured toner image is primarily transferred to said belt (41) from said four photosensitive drums (47A, 47B, 47C, 47D) and an image supporter such as the paper P is fed between said heat roller (46) and said press roller (49) and said coloured toner image is secondarily transferred and fused to said image supporter.

Although this invention is explained more concretely by the embodiments below, the range of this invention is not restricted to these embodiments.

### Preferred Embodiments to put the Invention into Practice

[Embodiment 1]

Tetrabutoxy zirconium was used as an inorganic component and silanol terminated polydimethylsiloxane (weight-average molecular weight 6000) and 3.3.3 trifluoropropyl trimethoxysilan were used as organic components. Silanol terminated polydimethyl siloxane:tetra butoxy zirconium:ethylacetoacetate:water:3.3.3.trifluoropropyl trimethoxysilan (0.2:1:2:2:1 molar ratio) were mixed enough to carry out the hydrolysis of said tetrabutoxy zirconium and the condensation polymerization of a part of said tetrabutoxy zirconium with said silano terminated polydimethyl siloxane with enough agitation for 0.5 hour to prepare an organic-inorganic hybrid sol solution. The concentration of said organosilicon compound containing fluoroalkyl group in the resulting sol solution was 1.04% by weight.

A base in which said sol solution was used to coat was a transferring and fusing belt base made of a polyimide resin mixed with conductive filler, and the surface of said base was washed and cleaned and then treated with the ultraviolet irradiation, and their said belt base was set in the flow coating machine and the surface of said base was coated with said organic-inorganic hybrid sol solution. Said coating layer was heated in the air atmosphere at 200° C. for 0.5 hour and at 350° C. for 0.1 hour to form an organic-inorganic hybrid releasing layer containing fluoroalkyl group in said base.

The thickness, the surface roughness Ra, the pencil hardness, the contact angle for water, the static coefficient of friction, the dynamic coefficient of friction, the minute hardness, and the gloss of said organic-inorganic hybrid containing fluoroalkyl group prepared in Embodiment 1 were determined. As the result, the thickness of said releasing layer was 20.0 μm, the surface roughness Ra=0.04 μm, the pencil hardness was 2H, the contact angle for water was 105.1°, the static coefficient of friction was 0.31, the dynamic coefficient of friction was 0.22, the minute hardness was 0.879, and the gloss was 100.

For the off-set estimation, the fusion estimation bench was carried out at a fusion temperature 170° C. As the result, no off-set inferior was observed. Further the toner off-set ΔC*=1.0 and this value was put in the standard.

[Embodiment 2]

Tetrabutoxy zirconium was used as an inorganic component and silanol terminated polydimethyl siloxan (weight-average molecular weight 6000) and 3.3.3-trifluoropropyl trimethoxysilan were used as organic compounds. Using ethanol as a solvent silanol terminated polydimethylsiloxan:tetrabutoxy zirconium:ethyl aceto acetate:water:3.3.3.trifluoropropyltrimethoxysilan (0.2:1:2:2:2 molar ratio) were mixed enough to carry out the hydrolysis and the condensation polymerization of a part of said tetrabutoxy zirconium with said silanol) terminated polydimethyl siloxane with enough agitation for 0.5 hour to prepare an organic-inorganic hybrid sol solution. The concentration of said organosilicon compound containing fluoroalkyl group in the resulting sol solution was 20.8% by weight.

A base on which said organic-inorganic hybrid sol solution was coated was a transferring and fusing belt base made of a polyimide resin in which a conductive filler was mixed, and the surface of said base was cleaned enough and then treated with the ultraviolet irradiation, and then said belt base was set in the flow coating machine and the surface of said belt base was coated with said organic-inorganic hybrid sol solution.

After then said coating layer was heated in the air atmosphere at 200° C. for 0.5 hour and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 20.0 μm, the surface roughness Ra=0.04 μm, the pencil hardness was 2H, the contact angle for water was 104.3°, the static coefficient of friction was 0.29, the dynamic coefficient of friction is 0.18, the minute hardness was 0.9 and the gloss is 100.

For the off-set estimation, the fusion estimation bench was carried out at a fusion temperature 170° C. As the result, no off-set inferior was observed. Further the toner off-setΔC*=1.0 and this value was put in the standard.

[Embodiment 3]

Titanium isopropylate (hereafter described simply TIP) was used as an inorganic component and silanol terminated polydimethyl siloxan (weight-average molecular weight 6000) and fluoroalkoxysilan were used as organic compounds. Silanol terminated polydimethylsiloxan:TIP:ethyl aceto acetate:water:fluoroalkoxysilan (0.2:1:2:2:1.5 molar ratio) were mixed enough to carry out the hydrolysis and the condensation polymerization of a part of said TIP with said silanol terminated polydimethyl siloxane with enough agitation for 0.5 hour to prepare an organic-inorganic hybrid sol solution. The concentration of said organosilicon compound containing fluoroalkyl group in the resulting sol solution was 15.6% by weight.

A base on which said organic-inorganic hybrid sol solution was coated was a transferring and fusing belt base made of a polyimide resin in which a conductive filler was mixed and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 20.0 μm, the surface roughness Ra=0.04 μm, the pencil hardness was 4H, the contact angle for water was 111.3°, the static coefficient of friction was 0.24, the dynamic coefficient of friction was 0.14.

For the off-set estimation, the fusion estimation bench was carried out at a fusion temperature 170° C. As the result, no off-set inferior was observed. Further the toner off-setΔC*=0.39 and this value was put in the standard.

[Embodiment 4]

TIP was used as an inorganic component and silanol terminated polydimethyl siloxan (weight-average molecular weight 6000) and fluoroalkoxysilan were used as organic compounds. Silanol terminated polydimethylsiloxan:TIP:ethyl aceto acetate:water:fluoroalkoxysilan (0.25:1:2:2:1.5 molar ratio) were mixed enough to carry out the hydrolysis and the condensation polymerization of a part of said TIP with said silanol terminated polydimethyl siloxane with enough agitation for 0.5 hour to prepare an organic-inorganic hybrid sol solution. The concentration of said organosilicon compound containing fluoroalkyl group in the resulting sol solution was 14.3% by weight.

A base on which said organic-inorganic hybrid sol solution was coated was a transferring and fusing belt base made of a polyimide resin in which a conductive filler was mixed, and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour, and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 20.0 μm, the surface roughness Ra=0.04 μm, the pencil hardness was 2H, the contact angle for water was 106.8°, the static coefficient of friction was 0.61, the dynamic coefficient of friction was 0.39.

For the off-set estimation, the fusion estimation bench was carried out at a fusion temperature 170° C. As the result, no off-set inferior was observed. Further the toner off-setΔC*=0.75 and this value was put in the standard.

[Embodiment 5]

TIP was used as an inorganic component and silanol terminated polydimethyl siloxan (weight-average molecular weight 6000) and fluoroalkoxysilan were used as organic compounds. Silanol terminated polydimethylsiloxan:TIP:ethyl aceto acetate:water:fluoroalkoxysilan (0.3:1:2:2:1.5 molar ratio) were mixed enough to carry out the hydrolysis and the condensation polymerization of a part of said TIP with said silanol terminated polydimethyl siloxane with enough agitation for 0.5 hours to prepare an organic-inorganic hybrid sol solution. The concentration of said organosilicon compound containing fluoroalkyl group in the resulting sol solution was 9.4% by weight.

A base on which said organic-inorganic hybrid sol solution was coated was a transferring and fusing belt base made of a polyimide resin in which a conductive filler was mixed and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 20.0 μm, the surface roughness Ra=0.04 μm, the pencil hardness was 4H, the contact angle for water was 106.3°, the static coefficient of friction was 0.73, the dynamic coefficient of friction was 0.46. For the off-set estimation, the fusion estimation bench was carried out at a fusion temperature 170° C. As the result, no off-set inferior was observed. Further the toner off-setΔC*=0.83 and this value was put in the standard.

[Embodiment 6]

TIP was used as an inorganic component and silanol terminated polydimethyl siloxan (weight average molecular weight 6000) and fluoroalkoxysilan were used as organic compounds. Silanol terminated polydimethylsiloxan:TIP:ethyl aceto acetate:water:fluoroalkoxysilan (0.4:1:2:2:1.5 molar ratio) were mixed enough to carry out the hydrolysis and the condensation polymerization of a part of said TIP with said silanol terminated polydimethyl siloxane with enough agitation for 0.5 hour to prepare an organic-inorganic hybrid sol solution. The concentration of said organosilicon compound containing fluoroalkyl group in the resulting sol solution was 8.3% by weight.

A base on which said organic-inorganic hybrid sol solution was coated was a transferring and fusing belt base made of a polyimide resin in which a conductive filler was mixed, and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour, and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 20.0 μm, the surface roughness Ra=0.04 μm, the pencil hardness was 6B, the contact angle for water was 106.2°, the static coefficient of friction was 0.91, the dynamic coefficient of friction was 0.55.

For the off-set estimation, the fusion estimation bench was carried out at a fusion temperature 170° C. As the result, no off-set inferior was observed. Further the toner off-setΔC*=0.88 and this value was put in the standard.

[Embodiment 7]

TIP was used as an inorganic component and silanol terminated polydimethyl siloxan (weight average molecular weight 6000) and fluoroalkoxysilan were used as organic compounds. Silanol terminated polydimethylsiloxan:TIP:ethyl aceto acetate:water:fluoroalkoxysilan (0.6:1:2:2:1.5 molar ratio) were mixed enough to carry out the hydrolysis and the condensation polymerization of a part of said TIP with said silanol terminated polydimethyl siloxane with enough agitation for 0.5 hour to prepare an organic-inorganic hybrid sol solution. The concentration of said organosilicon compound containing fluoroalkyl group in the resulting sol solution was 6.8% by weight.

A base on which said organic-inorganic hybrid sol solution was coated was a transferring and fusing belt base made of a polyimide resin in which a conductive filler was mixed, and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 20.0 μm, the surface roughness Ra=0.04 μm, the pencil hardness was 6B, the contact angle for water was 107.2°, the static coefficient of friction was 1.01, the dynamic coefficient of friction was 0.51.

For the off-set estimation, the fusion estimation bench was carried out at a fusion temperature 170° C. As the result, no off-set inferior was observed. Further the toner off-setΔC*=0.95 and this value was put in the standard.

[Embodiment 8]

TIP was used as an inorganic component and silanol terminated polydimethyl siloxan (weight average molecular weight 6000) and fluoroalkoxysilan were used as organic compounds. Silanol terminated polydimethylsiloxan:TIP:ethyl aceto acetate:water:fluoroalkoxysilan (0.25:1:2:2:2 molar ratio) were mixed enough to carry out the hydrolysis and the condensation polymerization of a part of said TIP with said silanol terminated polydimethyl siloxane with enough agitation for 0.5 hour to prepare an organic-inorganic hybrid sol solution. The concentration of said organosilicon compound containing fluoroalkyl group in the resulting sol solution was 28.6% by weight.

A base on which said organic-inorganic hybrid sol solution was coated was a transferring and fusing belt base made of a polyimide resin in which a conductive filler was mixed, and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 20.0 μm, the surface roughness Ra=0.04 μm, the pencil hardness was 2H, the contact angle for water was 107.3°, the static coefficient of friction was 0.70, the dynamic coefficient of friction was 0.49.

For the off-set estimation, the fusion estimation bench was carried out at a fusion temperature 170° C. As the result, no off-set inferior was observed. Further the toner off-setΔC*=0.65 and this value was put in the standard.

[Embodiment 9]

TIP was used as an inorganic component and silanol terminated polydimethyl siloxan (weight average molecular weight 6000) and fluoroalkoxysilan were used as organic compounds. Silanol terminated polydimethylsiloxan:TIP:ethyl aceto acetate:water:fluoroalkoxysilan (0.3:1:2:2:2 molar ratio) were mixed enough to carry out the hydrolysis and the condensation polymerization of a part of said TIP with said silanol terminated polydimethyl siloxane with enough agitation for 0.5 hour to prepare an organic-inorganic hybrid sol solution. The concentration of said organosilicon compound containing fluoroalkyl group in the resulting sol solution was 12.5% by weight.

A base on which said organic-inorganic hybrid sol solution was coated was a transferring and fusing belt base made of a polyimide resin in which a conductive filler was mixed and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 20.0 μm, the surface roughness Ra=0.04 μm, the pencil hardness was F, the contact angle for water was 106.5°, the static coefficient of friction was 0.66, the dynamic coefficient of friction was 0.43.

For the off-set estimation, the fusion estimation bench was carried out at a fusion temperature 170° C. As the result, no off-set inferior was observed. Further the toner off-setΔC*=0.72 and this value was put in the standard.

[Embodiment 10]

TIP was used as an inorganic component and silanol terminated polydimethyl siloxan (weight average molecular weight 6000) and fluoroalkoxysilan were used as organic compounds. Silanol terminated polydimethylsiloxan:TIP:ethyl aceto acetate:water:fluoroalkoxysilan (0.3:1:2:2:3 molar ratio) were mixed enough to carry out the hydrolysis and the condensation polymerization of a part of said TIP with said silanol terminated polydimethyl siloxane with enough agitation for 0.5 hour to prepare an organic-inorganic hybrid sol solution. The concentration of said organosilicon compound containing fluoroalkyl group in the resulting sol solution was 18.8% by weight.

A base on which said organic-inorganic hybrid sol solution was coated was a transferring and fusing belt base made of a polyimide resin in which a conductive filler was mixed and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 20.0 μm, the surface roughness Ra=0.04 μm, the pencil hardness was H, the contact angle for water was 107.6°, the static coefficient of friction was 0.58, the dynamic coefficient of friction was 0.34.

For the off-set estimation, the fusion estimation bench was carried out at a fusion temperature 170° C. As the result, no off-set inferior was observed. Further the toner off-setΔC*=0.63 and this value was put in the standard.

[Embodiment 11]

TIP was used as an inorganic component and dimethyldiethoxysilan and 3.3.3-trifluoroporpyltriethoxysilan were used as organic compounds. Dimethyldiethoxysilan:TIP:acetic acid:water:3.3.3-trifluoropropyltriethoxysilan (9:1:0.05:18:2.0 molar ratio) were mixed to prepare an organic-inorganic sol solution. The concentration of said organosilicon compound containing fluoroalkyl group in the resulting sol solution was 15.8% by weight.

A base on which said organic-inorganic hybrid sol solution was coated was a transferring and fusing belt base made of a polyimide resin in which a conductive filler was mixed, and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour, and at 350° C. for 0.1 hour to form an organic-inorganic hybrid releasing layer containing fluoroalkyl group on the surface of said base.

The thickness of the resulting organic-inorganic hybrid releasing layer containing fluoroalkyl group was 15.0 μm, the surface roughness Ra=0.04 μm, the pencil hardness was H, the contact angle for water was 104.2°, the static coefficient of friction was 0.29, the dynamic coefficient of friction was 0.19.

For the off-set estimation, the fusion estimation bench was carried out at a fusion temperature 170° C. As the result, no off-set inferior was observed. Further the toner off-setΔC*=0.61 and this value was put in the standard.

Further said releasing layer in this embodiment has an excellent toner releasing property and wears resistance so that the image inferior such as off-set, toner distortion, off position, and the like can be improved in said transferring and fusing belt having said releasing layer.

Still further since said releasing layer in this embodiment has a high gloss, a high quality image in the photograph level can be obtained when said transferring and fusing belt is used especially in a machine putting out a high quality image.

[Comparison 1]

TIP was used as an inorganic component and silanol terminated polydimethyl siloxan (weight average molecular weight 6000) were used as organic compounds. Silanol terminated polydimethylsiloxan:TIP:ethyl aceto acetate:water (0.31:1:2:2 molar ratio) were mixed enough to carry out the hydrolysis and the condensation polymerization of a part of said TIP with said silanol terminated polydimethyl siloxane with enough agitation for 0.5 hour to prepare an organic-inorganic hybrid sol solution.

A base on which said organic-inorganic hybrid sol solution was coated was a transferring and fusing belt base made of a polyimide resin in which a conductive filler was mixed and the surface of said base was cleaned enough and then treated with the ultraviolet irradiation, and then said belt base was set in the flow coating machine and the surface of said base was coated with said organic-inorganic hybrid sol solution.

After then said coating layer was heated in the air atmosphere at 200° C. for 0.5 hour and at 350° C. for 0.1 hour to form an organic-inorganic hybrid releasing layer containing fluoroalkyl group on the surface of said base.

The thickness of the resulting organic-inorganic hybrid releasing layer was 20.0 μm, the surface roughness Ra=0.04 μm, the pencil hardness was B, the contact angle for water was 106.0°, the static coefficient of friction was 0.66, the dynamic coefficient of friction was 0.42.

For the off-set estimation, the fusion estimation bench was carried out at a fusion temperature 170° C. As the result, said releasing layer has an inferior transferring and fusing properties and off-set inferior was recognized. Further the toner off-setΔC*=4.00 and this value was out of standard.

1. Transferring and/or fusing part(s) for electrophotographic use wherein an organic-inorganic hybrid releasing layer having fluoroaklyl group is formed on the base surface of said part(s).

2. Transferring and/or fusing part(s) for electrophotographic use in accordance with claim 1, wherein said base is made of polyimide resin.

3. Transferring and/or fusing part(s) for electrophotographic use in accordance with claim 1 or 2, wherein said organic-inorganic hybrid material is a reactant of alkoxide of a metal or a semimetal and organosilicon compound.

4. Transferring and/or fusing part(s) for electrophotographic use in accordance with claims 1 to 3 wherein said transferring and/or fusing part(s) is an intermediate transferring belt or an intermediate transferring drum or a transferring and fusing belt, and the base of said intermediate transferring belt or said transferring and fusing belt is made of an electroconductive resin base and the base of said intermediate transferring drum is a cylindrical metal core.

5. Transferring and/or fusing part(s) for electrophotographic use in accordance with claims 1 to 4 wherein the thickness of said releasing layer having fluoroalkyl group is in the range of between 0.05 and 100 μm.

6. Transferring and/or fusing part(s) for electrophotographic use in accordance with claims 1 to 5, wherein ultraviolet irradiation treatment is used onto the surface of said resin base of said intermediate transferring belt or said transferring and fusing belt before said releasing layer is formed.

7. Transferring and/or fusing part(s) for electrophotographic use in accordance with claims 1 to 6, wherein an adhesive layer made of a metal oxide formed by the sol-gel process intermediates between said resin base and said releasing layer of said intermediate transferring belt or said transferring and fusing belt.

8. Transferring and/or fusing part(s) for electrophotographic use in accordance with claims 4 to 7, wherein the surface resistance of said intermediate transferring belt or said intermediate transferring drum or said transferring and fusing belt is in the range of between 5 and 14 log Ω/□ and the volume resistance of said intermediate transferring belt or said intermediate transferring drum or said transferring and fusing belt is in the range of between 5 and 13 log Ω·cm.

9. Transferring and/or fusing part(s) for electrophotographic use in accordance with claims 1 to 3, wherein said transferring and fusing part(s) is a fusing roller or a fusing belt.

10. Transferring and/or fusing part(s) for electrophotographic use in accordance with claim 9, wherein the thickness of said releasing layer made of organic-inorganic hybrid material containing fluoroalkyl group is in the range of between 0.2 and 40 mm in the case of said fusing roller, and 0.05 and 100 μm in the case of said fusing belt.

11. Transferring and/or fusing part(s) for electrophotographic use in accordance with claim 9 or 10, wherein the base of said fusing roller is a cylindrical metal core or a cylindrical metal core covered with a resin and the base of said fusing belt is a resin base.

12. Transferring and/or fusing part(s) for electrophotographic use in accordance with claims 9 to 11, wherein ultraviolet irradiation treatment is used on the surface of said resin base before said releasing layer is formed.

13. Transferring and/or fusing part(s) for electrophotographic use in accordance with claims 9 to 12, wherein an adhesive layer made of a metal oxide formed by the sol-gel process intermediates between said resin base and said releasing layer.
